(19) United States
(12) Patent Application Publication
(10) Pub. No.: US 2022/0070353 A1
(43) Pub. Date: Mar. 3, 2022

(54) UNMANNED AERIAL VEHICLE ILLUMINATION SYSTEM

(71) Applicant: SHIELD AI, San Diego, CA (US)

(72) Inventors: Christian Reber WESTER, San Diego, CA (US); Andrew Philip REITER, San Diego, CA (US); William von NOVAK, San Diego, CA (US); Connor Russell KITE, San Diego, CA (US); Mitchel Joseph WHITE, San Diego, CA (US); Gabriel Isaac MAYO, North Potomac, MD (US); Scott Donald HOLLWEDEL, San Diego, CA (US); Mark David WHITE, San Diego, CA (US)

(21) Appl. No.: 17/412,119

(22) Filed: Aug. 25, 2021

Related U.S. Application Data
(60) Provisional application No. 63/071,322, filed on Aug. 27, 2020.

(51) Int. Cl. H04N 5/235; H04N 5/225; H04N 5/247; H04N 9/04

(52) U.S. Cl. CPC H04N 5/2352; H04N 9/045; H04N 5/247; H04N 5/2256

(57) ABSTRACT

A method of controlling camera and illumination systems may trigger a camera system to start exposing. An illumination system is also triggered to illuminate an infrared exposure of the camera system. The method also triggers multiple camera and illumination systems. In addition, a method of identification by a transmitter is provided. The method provides for modulating an infrared light source with a unique pattern to identify an unmanned aerial vehicle (UAV) and then sending the modulated light pattern to a receiver.

### CROSS REFERENCE TO RELATED APPLICATION

The present application claims the benefit of U.S. provisional patent application No. 63/071,322, filed Aug. 27, 2020, in the names of WESTER et al., the disclosure of which is expressly incorporated by reference in its entirety.

### FIELD OF THE DISCLOSURE

Aspects of the present disclosure generally relate to unmanned aerial vehicle (UAV) operations, and more particularly to techniques and apparatuses for UAV illumination systems.

### BACKGROUND

An unmanned aerial vehicle (UAV), commonly known as a drone, is an aircraft without a human pilot on board. UAVs may operate with various degrees of autonomy, either autonomously using on-board computers, or under remote control by a human operator. The definition provides for a powered, aerial vehicle that does not carry a human operator, uses aerodynamic forces to provide vehicle elevation, can fly autonomously or by remote piloting, may be expendable or recoverable, and can carry a payload. UAVs are used in multiple applications including military, commercial, scientific, and agricultural. Some uses include policing, surveillance, product delivery, aerial photography, infrastructure inspections, and drone racing.

UAVs are a component of an unmanned aircraft system, which includes a ground-based controller and a communication system linking the controller and UAV. The unmanned aircraft system may include ground control stations, data links, and support equipment. The UAV may be a quadcopter that has a body containing a power supply and a microcontroller unit (MCU). The system hardware for a UAV includes a flight controller, sensors, and actuators. System software is known as the flight stack or autopilot and is designed to provide a real-time rapid response to changing sensor data.

Sensors provide information about the state of the aircraft and include position and movement sensors. The multiple sensors may also connect to camera systems and digital video recording systems. As UAVs have developed and become more widely used, the need for nighttime operations has also grown. A UAV uses multiple vision systems to facilitate navigation and information collection. Two types of camera systems may be used: red, green, blue (RGB) cameras and stereo depth cameras. The RGB cameras primarily provide video streaming and image capture, and the stereo depth cameras primarily provide state estimation and navigation.

In order to function in both daytime and nighttime, the vision systems utilize a series of illuminators placed around the UAV body. The RGB cameras specify one type of illumination and the stereo depth cameras specify another type of illumination. These disparate needs necessitate two illumination systems. In some situations, the needs of the vision systems adversely affect each other. If infrared (IR) pattern projector illuminators are active while the RGB cameras are exposing, the RGB image will have an IR projector illuminator pattern on the image. In addition, users of night vision goggles may be affected when the pattern and floodlight illuminators are triggered at a frequency lower than a sampling rate of the human eye, producing a strobe light effect. The night vision goggles may also see the IR projector illuminator pattern projected on the image. There is a need for control of the illumination systems to coordinate each illumination system with dynamic camera operations to enhance image quality and vision system performance, and mitigate adverse effects to nearby users with night vision goggles.

### SUMMARY

The disclosure provides an apparatus for controlling camera systems and illumination systems. The apparatus includes a depth camera system and a vision camera system. A microcontroller unit is in communication with the depth camera system and the vision camera system. The microcontroller unit provides multiple options to control the camera and illumination systems including variable exposure times, brightness, among others.

In addition, the disclosure provide a method of controlling camera systems and illumination systems. The method starts with triggering a first camera system to start exposing. The method also provides for triggering a first illumination system to illuminate an exposure of the first camera system. Then, the method provides for stopping the first camera system and the first illumination system at a first later time. A wait period of a selected time interval follows. After the wait period, the method continues with triggering a second camera system to start exposing and triggering a second illumination system to illuminate an exposure of the second camera system. The method concludes with stopping the second camera system and the second illumination system at a second later time.

Furthermore, the disclosure also provides a method of identification by a transmitter. The method provides for modulating an infrared light source with a unique pattern to identify an unmanned aerial vehicle (UAV). The method continues with sending the modulated light pattern to a receiver.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIGS. 1A and 1B are diagrams illustrating a top view and a side view, respectively, of an unmanned aerial vehicle (UAV).

FIG. 2 is a block diagram of a microcontroller unit (MCU) for an unmanned aerial vehicle (UAV).

FIG. 3 is a timing diagram illustrating camera exposure synchronization in an unmanned aerial vehicle (UAV).

FIGS. 4A and 4B are diagrams illustrating a top view and a side view, respectively, of multiple illumination systems installed in an unmanned aerial vehicle (UAV), in accordance with various aspects of the present disclosure.

FIG. 5 is a block diagram illustrating an example of a dot pattern output by an infrared (IR) pattern projector, according to aspects of the present disclosure.

FIG. 6 is a schematic diagram of an unmanned aerial vehicle (UAV) projector illumination control system, in accordance with various aspects of the present disclosure.

FIG. 7 is a block diagram of a depth camera interface of an unmanned aerial vehicle (UAV) system, in accordance with various aspects of the present disclosure.

FIG. 8A is a block diagram of a current control system for a floodlight illumination system, in accordance with aspects of the disclosure.

FIG. 8B is a block diagram of a current control system for an infrared (IR) pattern projector system, in accordance with aspects of the disclosure.

FIG. 9 is a timing diagram illustrating synchronization between the infrared (IR) pattern projector system of FIG. 8B and the floodlight illumination system of FIG. 8A, in accordance with aspects of the disclosure.

FIG. 10 is a timing diagram showing creation of a strobing effect, in accordance with aspects of the disclosure.

FIG. 11 is a timing diagram showing use of dummy pulses to eliminate the strobing effect, in accordance with aspects of the disclosure.

FIG. 12 is a timing diagram showing floodlight usage to eliminate the strobing effect, in accordance with aspects of the disclosure.

FIG. 13 is a flow diagram illustrating a method for controlling a camera and an illumination system, in accordance with various aspects of the present disclosure.

FIG. 14 is a flow diagram illustrating a method of identification, by a transmitter, in accordance with various aspects of the present disclosure.

FIG. 15 is a flow diagram illustrating a method of identification, by a receiver, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure disclosed, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of unmanned aerial vehicle (UAV) systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

Unmanned aerial vehicles (UAVs) may use multiple vision systems to facilitate navigation and information collection. These vision systems can be placed into two general categories: red, green, blue (RGB) cameras for video streaming and image capture, and stereo depth cameras for state estimation and navigation. UAVs operate in both day and night. For nighttime operation, UAV vision systems have a series of illuminators placed around the body of the UAV. The RGB cameras have a dedicated illumination system and the stereo depth cameras have a separate, dedicated illumination system.

Each camera system has its own specifications for an illumination system. The specifications for one illumination system can negatively affect the other illumination system. These negative effects may include image quality degradation, depth measurement, and user vision. User vision may also be affected if night vision goggles are worn. Aspects of this disclosure address the negative effects by linking control of the illumination system with control of dynamic camera operation in order to enhance image quality and vision system performance.

An unmanned aerial vehicle (UAV) vision system may incorporate multiple camera systems each dedicated to a particular function. Each of the vision systems may use multiple cameras.

The disclosure provides an apparatus for controlling camera systems and illumination systems. The apparatus includes a depth camera system and a vision camera system. A microcontroller unit is in communication with the depth camera system and the vision camera system. The microcontroller may control separate triggers for each camera and illumination system.

In addition, the camera system provides a method of controlling camera systems and illumination systems. The method begins with triggering a first camera system to start exposing. A first illumination system is also triggered to illuminate an exposure of the first camera system. At a first later time, the first camera system and the first illumination system are stopped. After stopping the first camera system and the first illumination system, waiting a selected time interval occurs. The method then continues with triggering a second camera system to start exposing. A second illumination system is also triggered to illuminate an exposure of the second camera system. At a second later time, the second camera system and the second illumination system are stopped.

Furthermore, the disclosure also provides a method of identification by a transmitter. The method begins with modulating an infrared light source with a unique pattern to identify an unmanned aerial vehicle (UAV). The modulated light pattern is then sent to a receiver.

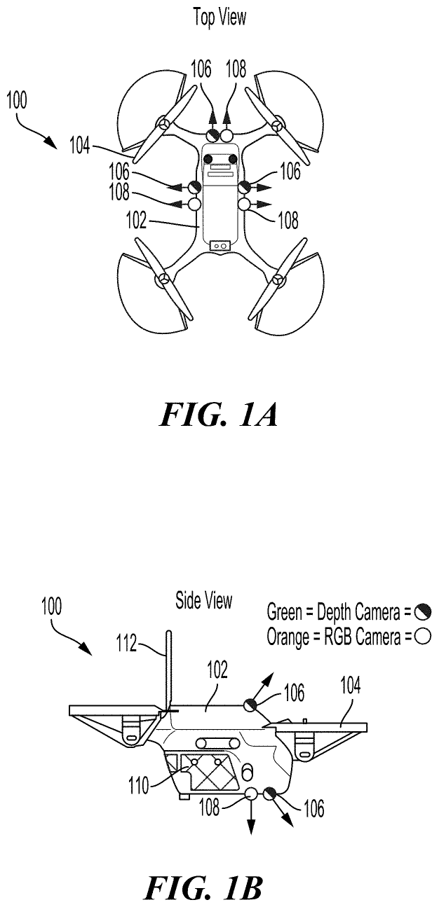

FIGS. 1A and 1B are diagrams illustrating a top view and a side view, respectively, of an unmanned aerial vehicle (UAV) assembly 100. The top view of FIG. 1A shows the UAV assembly 100 and a body 102. Propellers 104 are shown attached through pylons to the body 102. Each UAV vision system, including a red, green, blue (RGB) vision system and a depth camera system, uses multiple cameras. The RGB vision system uses three RGB cameras 108 facing forward, left, and right, as shown in the top view of FIG. 1A. The depth camera system uses five depth cameras 106 facing forward, left, right, up and down. The side view of FIG. 1B shows a depth camera 106 mounted on the top of the body 102 and depth camera 106 mounted on the underside of the body 102. The body 102 also includes an electronics bay 110 that houses the UAV electronics, including the microcontroller and flight controller. The body 102 also houses a battery that provides power to the UAV. An antenna 112 enables communications with a human operator, autonomous control system, or other UAVs.

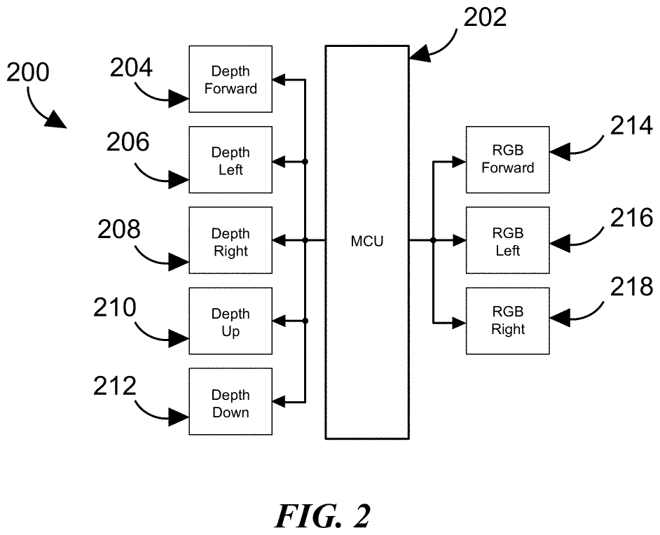

FIG. 2 is a block diagram of a microcontroller unit (MCU) for an unmanned aerial vehicle (UAV). In order to facilitate state estimation and the stitching of the captured images together, the vision systems may be synchronized. All of the depth cameras 106 start their exposures at the same time relative to each other. Similarly, the RGB cameras 108 also begin their exposures concurrently. A microcontroller circuit assembly 200 controls separate triggers for each of the vision systems. The microcontroller circuit assembly 200 includes a microcontroller unit (MCU) 202 that triggers the following cameras: a depth forward camera 204, a depth left camera 206, a depth right camera 208, a depth up camera 210, and a depth down camera 212. The MCU 202 also triggers the following cameras: an RGB forward camera 214, an RGB left camera 216, and an RGB right camera 218. The triggers for each vision system are shared by all of the cameras in a particular system.

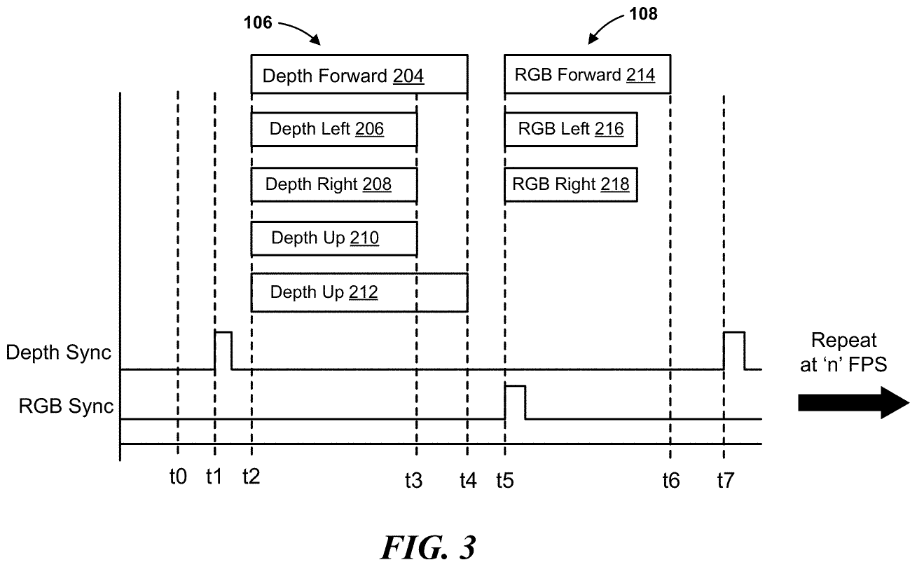

FIG. 3 is a timing diagram illustrating camera exposure synchronization in an unmanned aerial vehicle (UAV). Separate triggers control the timing for all cameras in a particular vision system. The exposures may start at the same time, but may end at different times. In FIG. 3, the horizontal axis represents elapsed time, and the vertical axis shows synchronization pulses for both the depth camera system (e.g., depth cameras 106) and the RGB camera system (e.g., RGB cameras 108).

The UAV commences operation at time tO. In operation, at time tl, a depth synchronization pulse triggers the depth cameras 106 to commence operation. All five depth cameras 106 begin operating at time t2. While all start operating at time t2, the depth forward camera 204 and the depth down camera 212 of the depth cameras 106 operate until time t4. The depth left camera 206, the depth right camera 208, and the depth up camera 210 of the depth cameras 106 operate until time t3. This allows cameras that need more exposure time (due to exposure to a darker scene, or different camera settings) to take longer to complete their exposures, and not be limited by the need to finish exposure at the same time as a camera with a shorter exposure.

By design, the exposure times for each vision system do not overlap. This allows each vision system to use a unique illumination system without interference from the other vision system. FIG. 3 shows that at time t5, the RGB cameras 108 begin operation. At time t5, the RGB forward camera 214, the RGB left camera 216, and the RGB right camera 218 of the RGB cameras 108 commence operation. The RGB left camera 216 and RGB right camera 218 halt operation before the RGB forward camera 214, which continues operating until time t6. After time t7, the patterns repeat at a selected frame per second (FPS) rate, shown as ‘n’ FPS in FIG. 3.

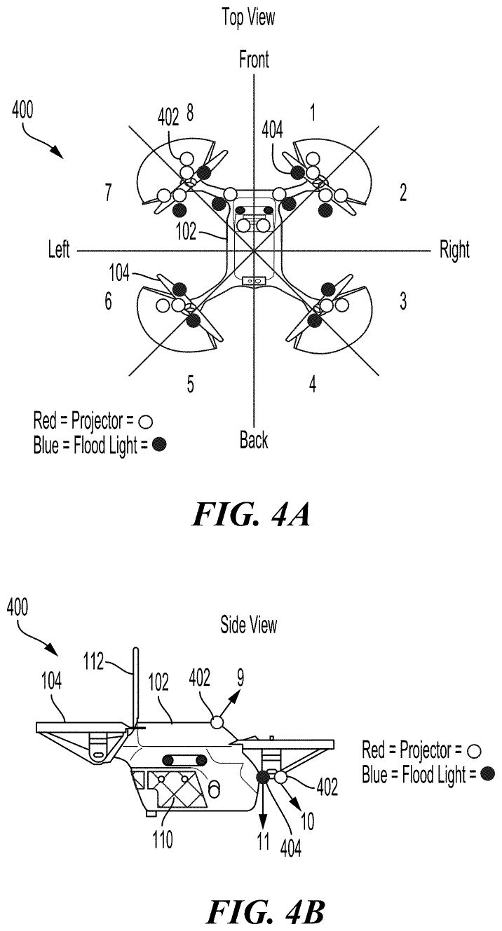

FIGS. 4A and 4B are diagrams illustrating a top view and a side view, respectively, of multiple illumination systems installed in an unmanned aerial vehicle (UAV), in accordance with various aspects of the present disclosure. Infrared (IR) illumination is used for the depth cameras 106 and the RGB cameras 108. As shown in FIG. 4A, the top view of an illumination system 400 uses multiple illuminators attached to the body 102 of the UAV. In the top view of FIG. 4A, the illumination system 400 shows the propellers 104 and their relation to the multiple illuminators. Two types of illuminators comprise the illumination system 400. Infrared (IR) pattern projector illuminators 402 operate in conjunction with depth cameras 106 (not shown). Floodlight illuminators 404 operate in conjunction with RGB cameras 108 (not shown). The side view of FIG. 4B shows the body 102 of the UAV, the propellers 104, electronics bay 110, and antenna 112. IR pattern projector illuminators 402 are shown installed on the top and underside of the body 102. A floodlight illuminator 404 is also installed on the underside of the body 102.

Infrared (IR) illumination is used for the depth cameras 106 and also for the RGB cameras 108. For each camera, there are corresponding illuminators pointed in the same direction as the camera. For example, the forward facing RGB camera 108 (not shown) has forward facing floodlight illuminators 404 shown by the markers in areas 1 and 8 in FIG. 4A. Areas 2-7 are similarly covered by both camera and illumination systems to ensure coverage around the UAV. Likewise, in FIG. 4B areas 9-11 are similarly covered by both camera and illumination systems to ensure coverage above and below the UAV. There is, however, a difference in the type of illumination used for the RGB cameras 108 and the depth cameras 106. The RGB cameras 108 use floodlight illuminators 404, which cast a wide beam of IR light, much like a flashlight. The depth cameras 106 use an IR pattern projector illuminator 402, which outputs a pattern, such as a dot pattern.

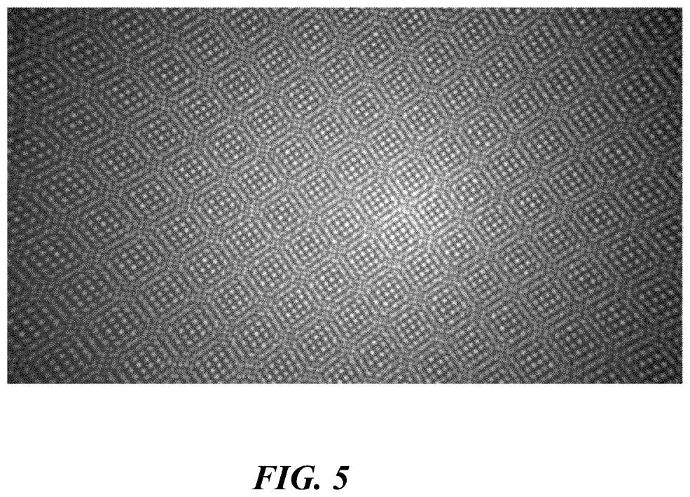

FIG. 5 is a block diagram illustrating an example of a dot pattern output by an infrared (IR) pattern projector illuminator, according to aspects of the present disclosure. The dot pattern in FIG. 5 is shown projected onto a wall. If the IR pattern projector illuminators 402 are turned on while the RGB cameras 108 are capturing images, the IR pattern projector illuminator dot pattern will appear on the images. This leads to poor image quality, and the possibility that a user cannot distinguish objects because of the obscuring dot pattern. This problem may be alleviated by turning off the IR pattern projector illuminators 402 during RGB camera 108 operation. This specifies that the depth and RGB systems turn on one at a time, in synchronization with the associated cameras, to ensure that images are free from dot patterns.

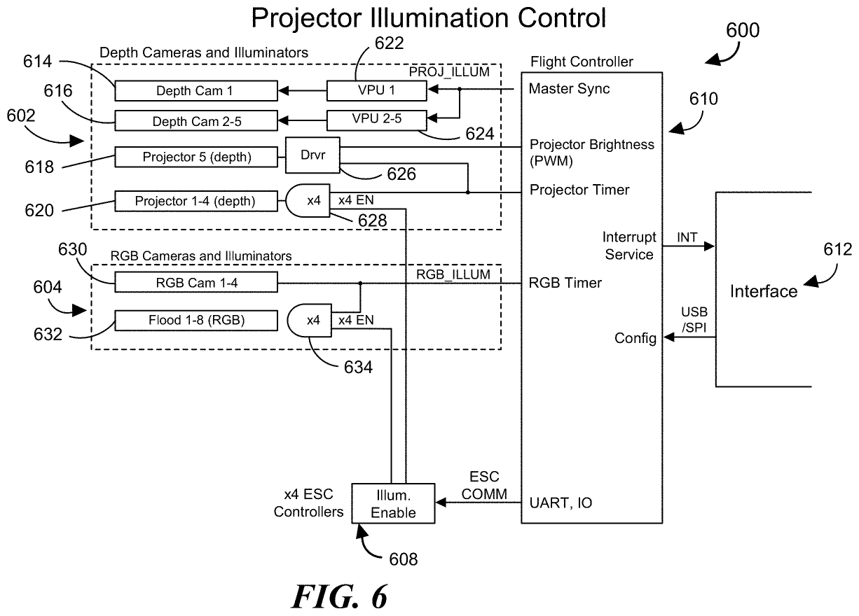

FIG. 6 is a schematic diagram of an unmanned aerial vehicle (UAV) projector illumination control system 600, in accordance with various aspects of the present disclosure. The UAV projector illumination control system 600 includes depth cameras and illuminators 602, and RGB cameras and illuminators 604. An illumination enable unit 608 selectively turns on and off each of the illumination systems as directed by a flight controller 610. The illumination enable unit 608 is also in communication with the electronic stability control (ESC) communications from a universal asynchronous receiver-transmitter (UART) input/output (I/O) module in the flight controller 610. The flight controller 610 is in communication with an interface 612 through an interrupt service connection and a configuration line using a universal serial bus (USB) or a serial peripheral interface (SPI).

Depth camera 1 614 receives input from a vision processing unit (VPU) 1 622, while depth cameras 2-5 616 receive input from VPUs 2-5 624. VPU 1 622 and VPU 2-5 624 are also in communication with one another and receive illumination operation instructions through a master synchronization (e.g., MASTER SYNC) command sent from the flight controller 610. Depth projector 5 618 is in communication with a driver 626. The driver 626 receives commands for projector brightness and projector timing from the flight controller 610. The projector brightness command is a pulse width modulated (PWM) signal. Depth projectors 1-4 620 are each in communication with a depth AND gate 628, which communicates with the illumination enable unit 608. The depth AND gate 628 is in communication with the illumination enable unit 608 and receives the projector timer command sent from the flight controller 610.

The RGB cameras 1-4 630 receive an RGB illumination command (e.g., RBG ILLUM) from the RGB timer in the flight controller 610. RGB floodlights 1-8 632 are in communication with an RGB AND gate 634, which communicates with the illumination enable unit 608.

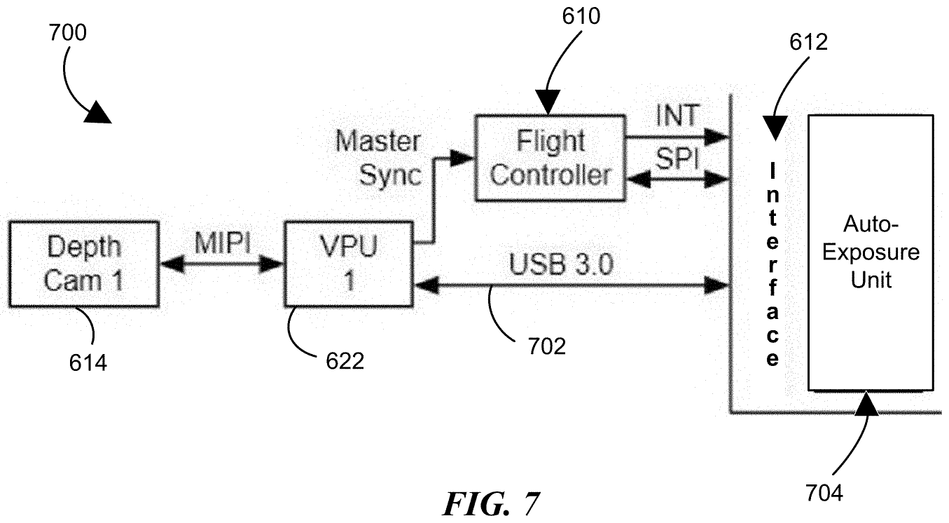

FIG. 7 is a block diagram of a depth camera interface 700 of an unmanned aerial vehicle (UAV) system, in accordance with various aspects of the present disclosure. The depth camera interface 700 illustrates the interface between a single depth camera 1 614 and the VPU 1 622. The interface between the depth camera 1 614 and the VPU 1 622 uses a mobile industry process interface (MIPI). The VPU 1 622 sends a master synchronization (MASTER SYNC) signal to the flight controller 610. The flight controller 610 communicates to the interface 612 through an interrupt line and has bi-directional communication with the interface 612 through a serial peripheral interface (SPI). The interface 612 communicates with the VPU 1 622 through a USB 3.0 interface 702. The interface 612 contains an auto-exposure unit 704.

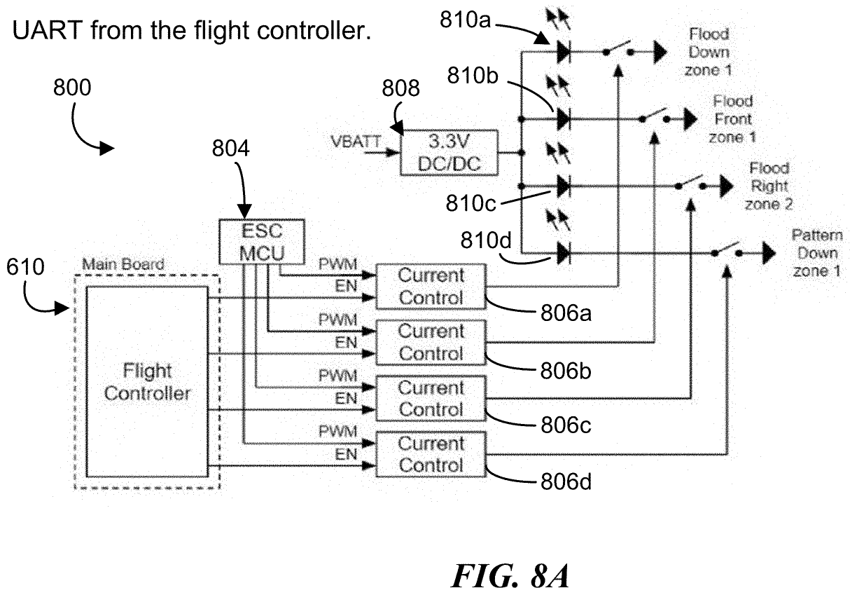

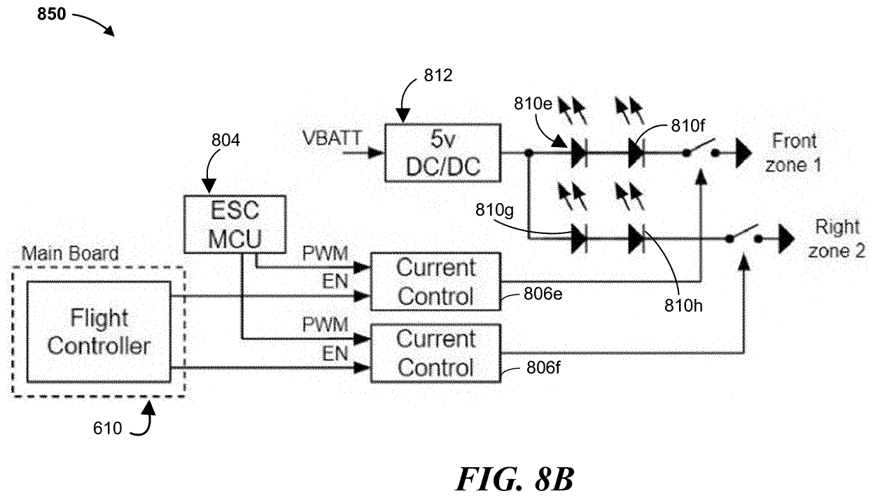

FIG. 8A is a block diagram of a current control system for a floodlight illumination system 800, in accordance with aspects of the disclosure. The floodlight illumination system 800 includes control mechanisms to control the current of the floodlight illuminators 404 (not shown). The flight controller 610 provides an enable signal (EN) to current control modules 806a, 806b, 806c, and 806d. An electronic speed control microcontroller unit (ESC MCU) 804 supplies a pulse width modulated (PWM) signal to each of the current control modules 806a, 806b, 806c, and 806d. The pulse width modulated input determines the current magnitude and an enable input sets the on/off timing. The pulse width modulated signals come from the ESC MCU 804 because these signals may vary slowly as commanded over the universal asynchronous receiver-transmitter (UART) from the flight controller 610. The enable (EN) signals come from the flight controller 610 and are synced with the camera exposure triggers. A power rail (e.g., 3.3 volt) powers the floodlight illuminators 404. A battery voltage signal (VBATT) is input to a DC/DC power supply 808 (3.3 volts). The DC/DC power supply 808 supplies power to each of the floodlight light emitting diodes (LEDs) 810a, 810b, 810c, and 810d. The LED 810a provides floodlight illumination to down zone 1 when a switch is closed by the current control module 806a. The LED 810b provides floodlight illumination to front zone 1 when a switch is closed by the current control module 806b. The LED 810c provides floodlight illumination to right zone 2 when a switch is closed by the current control module 806c. The LED 810d provides an IR pattern projection to pattern down zone 1 when a switch is closed by the current control module 806d.

FIG. 8B is a block diagram of a current control system for an infrared (IR) pattern projector illumination system 850, in accordance with aspects of the disclosure. The IR pattern projector illumination system 850 includes control mechanisms to control the current of the IR pattern projector illuminators 402 (not shown). The flight controller 610 provides an enable signal to current control modules 806e and 806f. The electronic speed control microcontroller unit (ESC MCU) 804 supplies a PWM signal to each of the current control modules 806e and 806f A battery voltage signal (VBATT) is input to a DC/DC power supply 812 (e.g., 5 volt). The power supply 812 supplies power to each of the IR pattern projector light emitting diodes (LEDs) 810e, 810f, 810g, and 810h. The LEDs 810e and 810f provide IR pattern projection illumination to front zone 1 when a switch is closed by the current control module 806e. The LEDs 810g and 810h provide IR pattern projection illumination to right zone 2 when a switch is closed by the current control module 806f

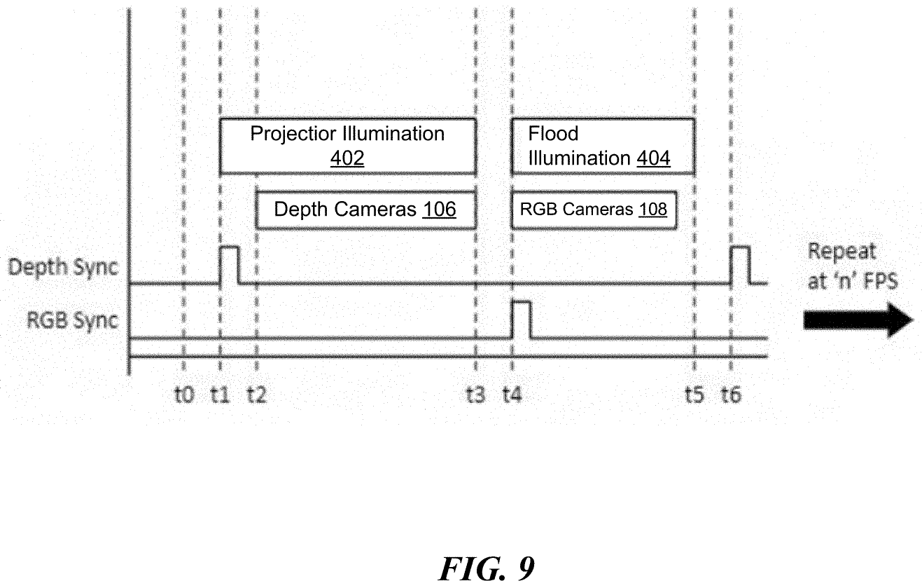

FIG. 9 is a timing diagram illustrating synchronization between the IR pattern projector illumination system 850 of FIG. 8B and the floodlight illumination system 800 of FIG. 8A, in accordance with aspects of the disclosure. Synchronizing the depth cameras 106, 206, 208, 210, and 212 with the RGB cameras 108, 214, 216, and 218 (shown in FIGS. 1A, 1B, and 2) solves the problem of the IR pattern being projected on the RGB images. This may be known as RGB image pollution. Solving the RGB image pollution problem relies on synchronizing the depth camera system (e.g., depth cameras 106) and the RGB camera systems (e.g., RGB cameras 108) to turn on one at a time. Avoiding overlap ensures that the images captured by the RGB cameras 108 are free of IR pattern projector dots. In FIG. 9, time is represented by the horizontal axis, and depth sync on/off and RGB sync on/off is plotted on the vertical axis. A high level represents on and a low level represents off

The UAV commences operation at time to. At time tl, a trigger pulse is transmitted on the depth sync input to the depth cameras 204, 206, 208, 210, and 212 (e.g., depth cameras 106). Also at time tl, the IR pattern projector illuminators 402 turn on in response to the trigger pulse. The IR pattern projector illuminators 402 remain on through to time t3. At time t2, the depth cameras 106, 204, 206, 208, 210, and 212 turn on and remain on in conjunction with the IR pattern projector illuminators 402. At time t3, both the IR pattern projector illuminators 402 and the depth cameras 106, 204, 206, 208, 210, and 212 turn off

At time t4, a trigger pulse is transmitted on the RGB sync input to the RGB cameras 214, 216, and 218 (e.g., RGB cameras 108) and also to the floodlight illuminators 404. The RGB cameras 214, 216, and 218 (e.g., RGB cameras 108) start their exposure at time t4 and turn off shortly before time t5. The floodlight illuminators 404 turn off at time t5. After time t6, the sequence repeats at a selected ‘n’ frames per second (FPS).

A further problem may be solved using the synchronization systems discussed above. With night vision goggles, the IR pattern projector illuminators 402 and the floodlight illuminators 404 may cause a strobing effect. The strobing effect is similar to a strobe light and is caused when the IR pattern projector illuminators 402 and the floodlight illuminators 404 are triggered at a frequency lower than the sampling rate of the human eye. The sampling rate for this strobing effect may occur, for example, at 30 Hz. This strobe effect is distracting and potentially nauseating for a human operator.

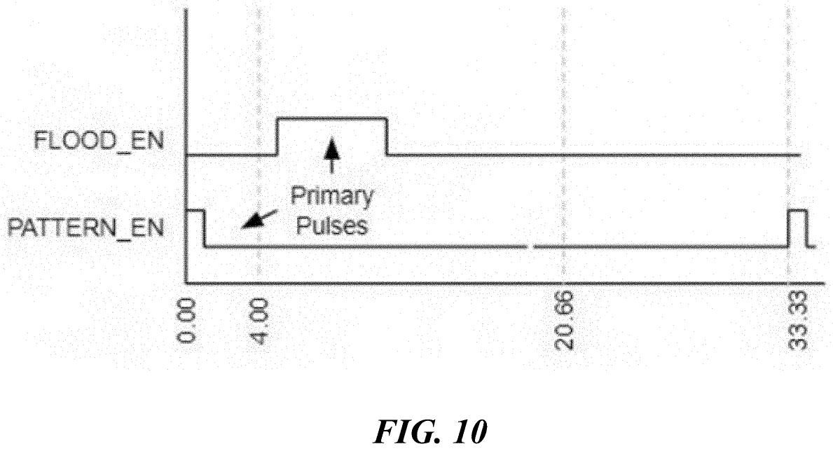

FIG. 10 is a timing diagram showing creation of a strobing effect, in accordance with aspects of the disclosure. Frequency is plotted along the horizontal axis, and the signals for floodlight illumination enable (FLOOD_EN) and IR pattern projector illumination (PATTERN_EN) are shown on the vertical axis. FIG. 10 shows the IR pattern projector illuminators and the floodlight illuminators turned on at a rate of 30 Hz. This is slow enough to cause the strobe light effect.

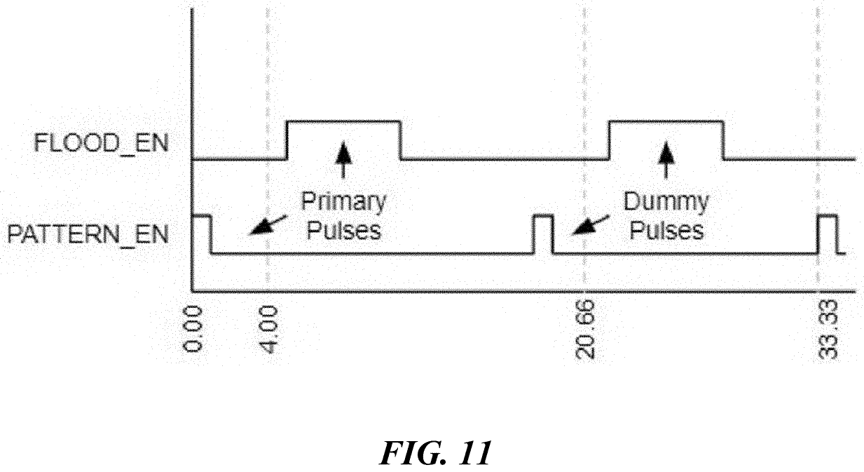

FIG. 11 is a timing diagram showing a use of dummy pulses to eliminate the strobing effect, in accordance with aspects of the disclosure. If the IR pattern projector illuminators 402 are triggered at a frequency greater than the sampling rate of the human eye, the dots of the IR pattern projection illuminators appear constant and not as strobe lights. This is accomplished by inserting a dummy pulse into the illumination triggering sequence, as shown in FIG. 11. The horizontal axis represents frequency, and the vertical axis shows the signals for FLOOD_EN and PATTERN_EN. No camera captures an image during the dummy pulses. The dummy pulses are inserted to eliminate the strobe light effect for the human operator. After the dummy pulses are inserted, each illumination system operates at 60 Hz, which is faster than the human eye can distinguish.

An alternative approach also eliminates the strobe light effect and does not use dummy pulses. An alternative approach leaves the floodlight illuminators 404 on for the majority of the time period and turns them off only when the IR pattern projector illuminators 402 are turned on. In this approach, the floodlight illuminators 404 may be run at 60 Hz, to give one example, while the IR pattern projector illuminators 402 operate at 30 Hz.

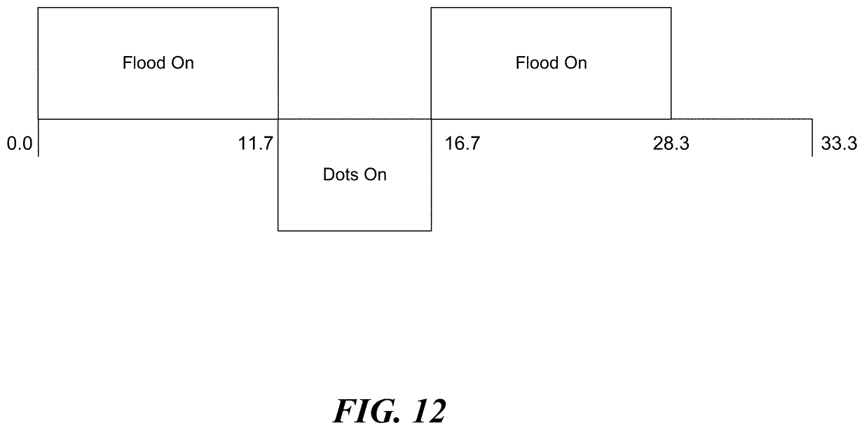

FIG. 12 is a timing diagram showing floodlight usage to eliminate the strobing effect, in accordance with aspects of the disclosure. In FIG. 12, time is shown on the horizontal axis, and the vertical axis shows cycling the floodlight illuminators 404 and the IR pattern projector illuminators 402. The floodlight illuminators 404 are on for a selected period of time and then turned off. The IR pattern projector illuminators 402 are then turned on for a selected period of time. This pattern repeats while the night vision goggles are in use.

Another approach allows adjusting the magnitude of the IR pattern projector illuminators 402 to reduce the brightness of the dot pattern. At the same time, the floodlight illuminators 404 brightness is increased. This approach also eliminates the strobe light effect of the dots to the human operator because the dots comprise a smaller portion of the total light the human operator sees over a period of time. It should be noted that operation of the floodlight illuminators 404 while the depth cameras 106, 204, 206, 208, 210, and 212 are operating reduces the accuracy and the effective range of the depth camera vision system.

While the approaches described above halt the strobing effect for an operator wearing night vision goggles, the constant dot pattern projected onto all surfaces viewed through the illumination systems remains. The dot pattern projected onto the landscape makes distinguishing objects difficult, if not impossible. Objects may appear simply as blobs. Much of this problem arises because night vision goggles amplify available light and many do not incorporate technologies that rely on frame rates or sampling techniques. If, however, the night vision goggles incorporate an image capture technology that uses a frame rate similar to the frame rate of the RGB cameras 214, 216, and 218 (e.g., RGB cameras 108), then the synchronization techniques described above can remove the dot pattern. This situation may be mitigated from the perspective of the wearer by increasing the time the floodlight illuminators 404 are turned on. In addition, the dot pattern may be removed by adjusting a magnitude of the brightness between the floodlight illuminators 404 to make the IR pattern projector illuminators 402 less bright compared to the floodlight illuminators 404.

In military UAV systems, especially swarm systems, identification friend or foe (IFF) systems are critical to distinguish between friendly and hostile assets. UAVs may be grouped into swarms, which are coordinated groups of UAVs operating together. IFF is challenging for swarm UAV systems due to size, weight, and power constraints. UAVs may incorporate light emitting diodes (LEDs) and vertical-cavity surface-emitting laser (VCSEL) diodes. VCSEL diodes emit perpendicularly from the top surface, which can be useful for communication within a swarm of UAVs. IFF between swarming UAVs relies on a high speed camera, with a speed significantly greater than the illumination frame rates (e.g., 120 frames per second.) A receiving camera recognizes the unique frame rate pattern emitted by the VCSEL and identifies the target as a swarm member. In addition, simple image recognition provides distance and altitude information once that pattern is acquired. Minor variations in the illumination pattern may be used to transmit additional information such as a unique vehicle identifier or “squawk” for each UAV. The minor variations in the illumination pattern may also convey vehicle state information. This vehicle state information may include incoming vehicle, departing vehicle, battery level, or damage state. The vehicle state information may be used by a receiving vehicle to estimate what route the emitting UAV will take, or to inform an operator about the state of the emitting UAV.

A modulation scheme may also be varied by adding an extra pulse during a time period when no cameras are exposing. A pulse may also be lengthened to extend into the time between camera exposures, also known as “dead time.” Further variations may include intentionally dropping an illumination time when the operational environment permits, such as when moving slowly, and varying the intensity. Intensity modulation that is insignificant from the illumination perspective can still be received and decoded for the transmission of information. The amount of data that may be sent depends largely on the frame rate of the receiving camera. Both LEDs and VCSELs are capable of modulations into the MHz, while even a fast camera often works below 100 Hz, resulting in the modulation scheme being limited by the receiving frame rate, not the transmission rate.

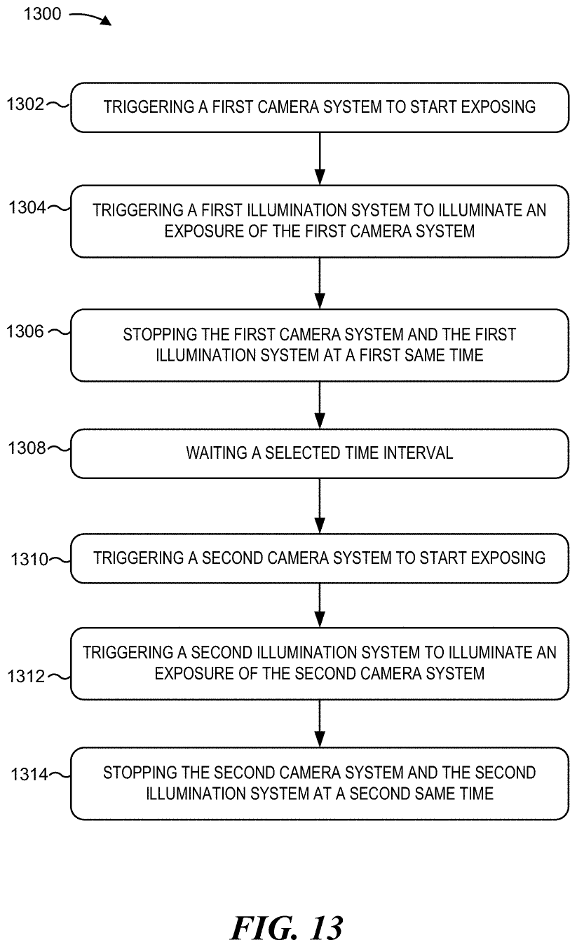

FIG. 13 is a flow diagram illustrating a method 1300 for controlling a camera and an illumination system, in accordance with various aspects of the present disclosure. The method 1300 begins in block 1302, with triggering a first camera system to start exposing. The first camera system may be a depth camera system, such as that shown in FIGS. 1A, 1B, and 2, with depth cameras 106, 204, 206, 208, 210, and 212. In block 1304, the method 1300 continues with triggering a first illumination system to illuminate an exposure of the first camera system. The first illumination system may be an infrared (IR) pattern projection illumination system that projects a dot pattern, such as that shown in FIG. 5, or the IR pattern projector illumination system 850 shown in FIG. 8B. In block 1306, stopping the first camera system and the first illumination system at a first same time occurs. This stops the depth cameras 106, 204, 206, 208, 210, and 212. Concurrently, the IR pattern projector illumination system 850 is stopped. Block 1308 provides for waiting a selected time interval. The selected time interval may be chosen based on the frame rates of the cameras. Then, in block 1310, the method 1300 continues with triggering a second camera system to start exposing. The second camera system may be the RGB cameras 108, 214, 216, and 218 of FIGS. 1A, 1B, and 2. Next, in block 1312, the method 1300 continues with triggering a second illumination system to illuminate an exposure of the second camera system. The second illumination system may be the floodlight illumination system 800 of FIG. 8A. The method 1300 concludes in block 1314, with stopping the second camera system and the second illumination system at a second same time. The RGB cameras 108, 214, 216, and 218 are stopped, as is the floodlight illumination system 800 of FIG. 8A.

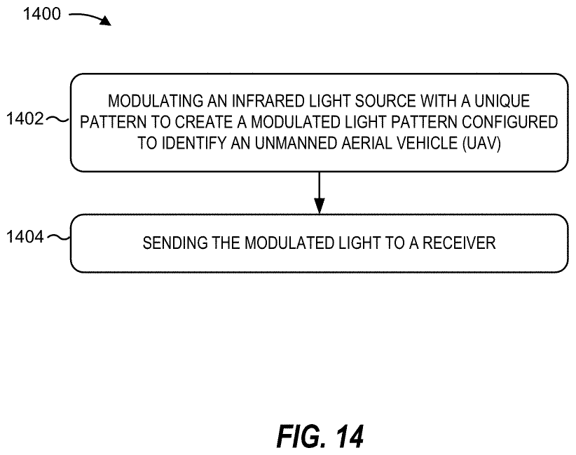

FIG. 14 is a flow diagram illustrating a method 1400 of identification, by a transmitter, in accordance with various aspects of the present disclosure. The method 1400 begins in block 1402, with modulating an infrared light source with a unique pattern to create a modulated light pattern to identify an unmanned aerial vehicle (UAV). The light source may be the floodlight illumination system 800 of FIG. 8A or may be the IR pattern projector illuminator 402 of FIGS. 4A and 4B. The method 1400 continues in block 1404, with sending the modulated light to a receiver. The receiver may be another UAV assembly 100, such as that depicted in FIGS. 1A and 1B.

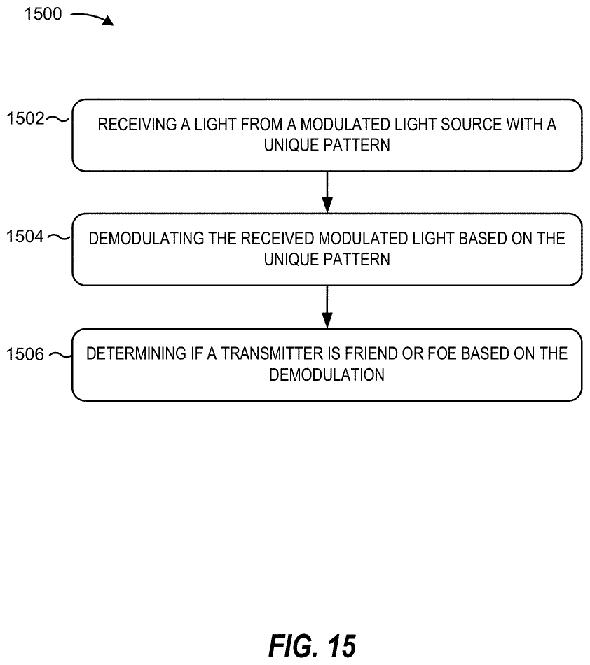

FIG. 15 is a flow diagram illustrating a method 1500 of identification, by a receiver, in accordance with various aspects of the present disclosure. The method 1500 begins in block 1502, with receiving light from a modulated light source with a unique pattern. The light source may be the IR pattern projector illuminator 402 of FIG. 4. The method 1500 continues in block 1504, with demodulating the received modulated light based on the unique pattern. The electronics in the UAV may perform the demodulation. The method 1500 concludes with block 1506, with determining if a transmitter is friend of foe based on the demodulation.

Additional aspects of the illumination management system provide knowledge of the camera systems exposure times. The sensors on the UAV may also receive a signal from each camera system when exposing stops. A further alternative allows firing the illumination systems 402 and 404 very brightly and briefly so that timing of the turn on/off is not necessary.

In addition, the illumination systems can automatically adjust each type of illumination system relative to the other. This minimizes the user's view of the projector pattern. As one example, if a brighter dot pattern is needed to increase the visible range of the depth camera system (e.g., 204, 206, 208, 210, and 212) then the brightness of the floodlight illumination system 400 also increases.

Illuminators can be selected with a light spectrum output that does not fall in the same band as night vision goggles. This may mitigate the pattern projection for a user of night vision goggles. This problem may also be mitigated by using light filters passing only a specific band of light. Night vision goggle users may also share a common synchronization signal with the illumination systems on the UAV to further mitigate the pattern projection seen when wearing the night vision goggles. Such a synchronization signal may also be shared with multiple UAVs flying in the same space, such as a room. Such a synchronization signal may be carried over a separate channel (e.g., a radio signal) or may come directly from the illuminators. For example, the night vision goggles may receive an IR signal from the illuminators and synchronize with it directly.

Each camera system, both depth cameras (204, 206, 208, 210, and 212) and RGB cameras (e.g., 214, 216, and 218) may have their own illuminators. With each camera having dedicated illuminators, depending on camera type, brightness adjustments for each camera are possible. These individually controlled illuminators also allow the system to dim or turn off when the UAV points directly at the user. This is particularly helpful when recovering the UAV. When the UAV is flying away from the user the illumination system can delay illumination to avoid revealing the user's location. This is of particular concern for military operations.

Users can also manually adjust the illumination system through the separately controllable illuminators. If a user does not want the UAV seen, all illumination systems can be turned off

Camera exposure time is also controllable. While each camera in a camera system receives an exposure trigger simultaneously, individual cameras may have unique brightness or exposure time duration, based on the view of each camera. In mobile vision systems, it is best to minimize camera exposure time. This ensures that motion blur caused by system movement is mitigated in the captured image. However, as the UAV, or mobile vision system, moves through varying light conditions, it may be helpful to increase exposure times in low light areas. The camera systems exposure timers are coupled with the illumination systems to provide this control. The illumination system can be turned on first to adjust brightness, preventing longer camera exposure times. The brightness of the illumination system can also be controlled by selectively turning on illuminators as desired and not just by brightness adjustments. The brightness adjustments occur quickly so that an individual camera's exposure control loop remains stable.

The illumination control systems minimize ripple in the current drive through the illuminators for constant illumination over the exposure period. Current adjustment in the illuminators can be accomplished with pulse-width modulation (PWM), a DC reference, or other desired current regulation scheme.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described this disclosure may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. An apparatus for controlling camera systems and illumination systems, comprising:
a depth camera system;
a vision camera system; and
a microcontroller unit in communication with the depth camera system and the vision camera system.

2. The apparatus of claim 1, in which the microcontroller unit controls separate triggers for the depth camera system and the vision camera system.

3. The apparatus of claim 2, in which the microcontroller unit triggers all cameras in the depth camera system and/or the vision camera system to start exposure at a same time.

4. The apparatus of claim 2, in which the microcontroller unit triggers all cameras in the depth camera system and/or the vision camera system to end exposure at different times.

5. The apparatus of claim 1, in which the microcontroller unit triggering the depth camera system and the vision camera system uses a different illumination system for each of the depth camera system and the vision camera system.

6. The apparatus of claim 5, in which the microcontroller unit triggers the depth camera system and/or the vision camera system such that exposure times for the depth camera system the vision camera system do not overlap.

7. The apparatus of claim 1, further comprising an illumination enable unit to selectively turn and off illumination systems as directed by a flight controller.

8. A method of controlling camera systems and illumination systems, comprising:
triggering a first camera system to start exposing;
triggering a first illumination system to illuminate an exposure of the first camera system;
stopping the first camera system and the first illumination system at a first later time;
waiting a selected time interval;
triggering a second camera system to start exposing;
triggering a second illumination system to illuminate an exposure of the second camera system; and
stopping the second camera system and the second illumination system at a second later time.

9. The method of claim 8, in which the first camera system is a depth camera system, the first illumination system is an infrared (IR) pattern projection illumination system, the second camera system is a red, green, blue (RGB) camera system, and the second illumination system is a floodlight illumination system.

10. The method of claim 9, further comprising triggering the IR pattern projection illumination system or the floodlight illumination system at a frequency greater than a human eye sampling rate.

11. The method of claim 8, further comprising inserting dummy pulses into an illumination triggering sequence to trigger at a frequency greater than a human eye sampling rate use.

12. The method of claim 8, further comprising:
reducing brightness of the first illumination system; and
increasing brightness of the second illumination system.

13. The method of claim 8, further comprising:
transmitting the first camera system exposure and the second camera system exposure to a set of night vision goggles; and
synchronizing a frame rate of the night vision goggles with a frame rate of the second camera system.

14. The method of claim 13, further comprising adjusting a first illumination system brightness to a lesser brightness relative to the second illumination system.

15. A method of identification by a transmitter, comprising:
modulating an infrared light source with a unique pattern to create a modulated light pattern configured to identify an unmanned aerial vehicle (UAV); and
sending the modulated light pattern to a receiver.

16. The method of claim 15, in which modulating the light source creates a unique identifier.

17. The method of claim 15, in which modulating the light source adds an extra pulse during a time when neither a first camera system nor a second camera system is exposing.

18. The method of claim 15, in which modulating the light source lengthens a pulse into a time between exposures by a first camera system and a second camera system.

19. The method of claim 15, further comprising dropping an illumination period of either a first illumination system or a second illumination system.

20. The method of claim 15, further comprising changing intensity of an illumination period of either a first illumination system or a second illumination system.
